(19) United States
(12) Patent Application Publication
(10) Pub. No.: US 2022/0335754 A1
(43) Pub. Date: Oct. 20, 2022

(54) ELECTRICAL ARCHITECTURE FOR SERVICE-ORIENTED VEHICLE DIAGNOSTICS

(71) Applicant: JAGUAR LAND ROVER LIMITED, Whitley, Coventry, Warwickshire (GB)

(72) Inventors: Dibyendu PALAI, Leamington Spa, Warwickshire (GB); Sachin SHINDE, Solihull, West Midlands (GB)

(21) Appl. No.: 17/639,864

(22) PCT Filed: Aug. 27, 2020
(86) PCT No.: PCT/EP2020/073946

§ 371 Date: Mar. 2, 2022

(30) Foreign Application Priority Data
Sep. 2, 2019 (GB) 1912568.1

(51) Int. Cl. G07C 5/00; B60W 50/02; B60R 16/023; G06F 13/42

(52) U.S. Cl. CPC G07C 5/008; B60W 50/0205; B60R 16/0232; G06F 13/4282; G06F 2213/0002

(57) ABSTRACT

A method of providing diagnostics communication in a diagnostics electrical architecture of a vehicle, the vehicle comprising a plurality of on-board computing devices for hosting the diagnostics electrical architecture. The diagnostics electrical architecture comprises: one or more electronic control units each comprising a diagnostics server module; a service interface module arranged to allow diagnostic communication between the one or more electronic control units and a network service bus of the vehicle; and a diagnostic services registry module. The method comprising: performing, by the diagnostics server module, diagnostic tasks to generate diagnostic object data; receiving into the service interface module the generated diagnostic object data; retrieving diagnostic services data from the diagnostic service registry module, the diagnostic services data comprising diagnostic capability descriptions of the generated diagnostic object data; and transmitting a diagnostic service notification over the network service bus, the diagnostic service notification being based on the generated diagnostic object data and the diagnostic services data.

### TECHNICAL FIELD

The present disclosure relates to a diagnostics electrical architecture for a vehicle and, in particular, a diagnostics electrical architecture hosted on a plurality of vehicle on-board computing devices. Aspects of the invention relate to a vehicle diagnostics electrical architecture, to a method, to a computer-readable medium, and to a vehicle.

### BACKGROUND

Modern vehicles, e.g. road vehicles such as cars, include a number of embedded electronic control units, components or modules (ECUs) for controlling and performing a number of functions of the vehicle. Examples of such ECUs may include an anti-lock braking system (ABS), a powertrain control module (PCM), a transmission control module (TCM), an instrument panel cluster (IPC), a ADAS domain controller (ADC), an engine management system (EMS), an air conditioning module (ACM), etc. Typically, each vehicle ECU is connected to a number of sensors of the vehicle and receives sensor data from the sensors as input, together with signals from other parts of the vehicle.

The electronic parts or software of an ECU, or the sensors connected to an ECU, can fail or develop faults. Many ECUs will include a local diagnostics server having self-diagnostic capabilities including being able to identify and report faults, and perhaps perform self-repair of faults.

Currently, diagnostic testing of a vehicle involves a diagnostic tester—which can be on-board or off-board the vehicle—establishing a point-to-point (p2p) diagnostic communication between the diagnostic tester and a local diagnostics server of any ECU of the vehicle. In particular, such diagnostic communication is made via a single central gateway that acts as a router for diagnostic messages to particular local diagnostic servers, specifically to route diagnostic messages between different transport protocols.

There are many potential disadvantages or drawbacks associated with the above-described present vehicle diagnostic architecture. These include, but are not limited to, static diagnostic configuration, lack of diagnostic redundancy, limitation to component-based diagnostics, diagnostic access limited to one tester at a time, and no logical and physical separation between external testers and vehicle modules leading to security risks. It is an aim of the present invention to address one or more of the disadvantages associated with the prior art.

### SUMMARY OF THE INVENTION

According to an aspect of the present invention there is provided a diagnostics electrical architecture for a vehicle, such as an automobile or other road-going vehicle. The vehicle comprises a plurality of on-board computing devices for hosting the diagnostics electrical architecture. The diagnostics electrical architecture comprises one or more electronic control units each comprising a diagnostics server module arranged to perform diagnostic tasks to generate diagnostic object data. The architecture comprises a service interface module arranged to allow diagnostic communication between the one or more electronic control units and a network service bus of the vehicle, the service interface module being arranged to receive the generated diagnostic object data. The architecture comprising a diagnostic services registry module arranged to store diagnostic services data indicative of diagnostic services provided by the service interface module, the diagnostic services data comprising diagnostic capability descriptions of the generated diagnostic object data. The service interface module is arranged to transmit a diagnostic service notification over the network service bus, where the diagnostic service notification is based on the generated diagnostic object data and the diagnostic services data retrieved from the diagnostic services registry.

The diagnostic service notification may be generated in response to a change in diagnostic capabilities provided by the service interface module.

The change in diagnostic capabilities may be caused by an addition or removal of diagnostic tasks performed by the one or more control units.

The change in diagnostic capabilities may be caused by addition or removal of an electronic control unit associated with the service interface module.

The diagnostic service notification may be generated in response to a request for diagnostic capabilities received by the service interface module.

The request for diagnostic capabilities may be received from a diagnostic tester off-board the vehicle. The generated service notification may be transmitted off-board the vehicle.

The generated diagnostic capability notification may be used to update the diagnostic register module.

The service interface module may be deployed on communication middleware on one or more of the on-board computing devices.

The communication middleware may be one of: SOME/IP (Scalable service-oriented middleware over IP); REST (Representational state transfer); and, DDS (Data distribution service).

The vehicle service bus may comprise an Ethernet backbone network.

The service interface module may be directly connected to the Ethernet backbone network.

The stored diagnostic services data may comprise an open diagnostic exchange (ODX) file to interpret the diagnostic object data.

The diagnostic services registry module may be arranged to allow modules on-board and off-board the vehicle to subscribe to thereto such that the modules dynamically learn the diagnostic services provided by the service interface module.

The diagnostics electrical architecture may be arranged to provide conversion between Unified Diagnostics Services (UDS) protocol communication and service-oriented diagnostics communication.

The diagnostics electrical architecture may be a hierarchical architecture having a component diagnostic layer and at least one supervisory diagnostic layer, the component diagnostic layer comprising the one or more electronic units.

The at least one supervisory diagnostic layer may comprise the service interface module.

The at least one supervisory diagnostic layer may comprise the diagnostic services registry module.

The at least one supervisory diagnostic layer may comprise a system diagnostic layer and a vehicle diagnostic layer at a higher level of the architecture than the system diagnostic layer. The vehicle diagnostic layer may comprise the service interface module, and the system diagnostic layer may comprise an application service module comprising a local diagnostic agent arranged to aggregate the generated diagnostic service notifications received from the electronic control units to generate a supervisory-level diagnostic service notification.

The supervisory-level diagnostic service notification may be used to update the diagnostic services registry module.

The service interface module may be hosted on a zonal input/output computing device of the vehicle or a central compute platform of the vehicle.

According to another aspect of the present invention there is provided a vehicle, such as an automobile or other road-going vehicle, comprising a network architecture having a plurality of computing devices and hosting the diagnostics electrical architecture described above.

According to another aspect of the present invention there is provided a method of providing diagnostics communication in a diagnostics electrical architecture of a vehicle, such as an automobile or other road-going vehicle. The vehicle comprises a plurality of on-board computing devices for hosting the diagnostics electrical architecture. The diagnostics electrical architecture comprises one or more electronic control units each comprising a diagnostics server module, a service interface module arranged to allow diagnostic communication between the one or more electronic control units and a network service bus of the vehicle, and a diagnostic services registry module. The method comprises performing, by the diagnostics server module, diagnostic tasks to generate diagnostic object data, and receiving into the service interface module the generated diagnostic object data. The method comprises retrieving diagnostic services data from the diagnostic service registry module, the diagnostic services data comprising diagnostic capability descriptions of the generated diagnostic object data. The method comprises transmitting a diagnostic service notification over the network service bus, the diagnostic service notification being based on the generated diagnostic object data and the diagnostic services data.

According to another aspect of the present invention there is provided a non-transitory computer-readable storage medium storing instructions thereon that when executed by one or more processors causes the one or more processors to perform the method described above.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 illustrates a vehicle diagnostics electrical architecture having a flat, non-hierarchical structure with signal-oriented diagnostic communication;

FIG. 2 illustrates a vehicle diagnostics electrical architecture according to another example of the invention, the vehicle diagnostics electrical architecture having a hierarchical structure with service-oriented diagnostic communication;

FIG. 3 illustrates an application service module of the diagnostics electrical architecture of FIG. 2;

FIG. 4 illustrates a vehicle network architecture comprising a number of computing devices, the vehicle network architecture indicating where layers of the diagnostics electrical architecture of FIG. 2 is hosted;

FIG. 5 illustrates the vehicle diagnostics electrical architecture of FIG. 2 for a vehicle direction indicator feature;

FIG. 6 illustrates the steps of a method of performing vehicle diagnostics communication using the vehicle diagnostics electrical architecture of FIG. 2;

FIG. 7 shows a vehicle in accordance with an example of an aspect of the invention, the vehicle including the network architecture of FIG. 4 hosting the diagnostics electrical architecture of FIG. 2; and

FIG. 8 illustrates a simplified example of an on-board computing device.

### DETAILED DESCRIPTION

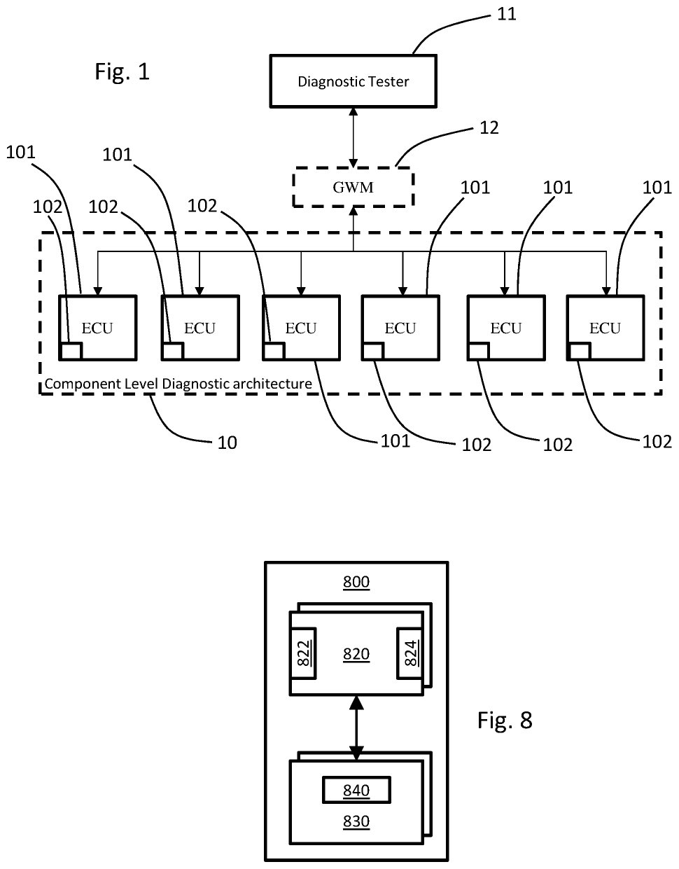

FIG. 1 illustrates a point-to-point (p2p) diagnostics electrical architecture 10 for a vehicle. The vehicle diagnostic architecture 10 has a plurality of electronic control units, components or modules (ECUs) 101 arranged logically in a flat, non-hierarchical structure 10, or component-level diagnostics architecture 10. The ECUs 101 each perform separate functions and may include an anti-lock braking system module (ABS), a powertrain control module (PCM), a transmission control module (TCM), an instrument panel cluster (IPC), an ADAS domain controller (ADC), an engine management system (EMS), and/or an air conditioning module (ACM). It will be understood that the vehicle diagnostic architecture 10 may include any number of suitable ECUs. Typically, the vehicle may include 40 to 60 ECUs.

Each of the ECUs 101 of the diagnostic architecture 10 can communicate with a diagnostic tester 11 on-board or off-board the vehicle. Indeed, the diagnostic tester 11 is able to directly establish diagnostic communication paths with any of the on-board ECUs 101. The diagnostic tester 11 is therefore able to initiate diagnostic communication and execute various diagnostic tasks such as initiating on-demand self-tests (ODST) of any of the ECUs 101 so that faults associated with the ECUs are reported back to the tester 11. In particular, diagnostic communication between each ECU 101 and the diagnostic tester 11 is made using a gateway module (GW M) 12. The diagnostic tester 11 may be any suitable vehicle diagnostic tester, e.g. an engineering, manufacturing or service tester, a connected diagnostics tester, or an on-board diagnostic or software-over-the-air (SOTA) tester. Indeed, vehicles commonly have a number of different diagnostic testers that communicate with on-board ECUs.

Each of the ECUs 101 of the diagnostics electrical architecture 10 has a local diagnostic server or module 102. Each diagnostics server 102 is arranged to perform self-diagnosis operations associated with its respective ECU 101, including identifying, reporting and/or repairing faults or failures of parts or software of the ECU 101, or sensors associated with the ECU 101. The diagnostic server 102 then reports back to the diagnostic tester 11 any identified faults or errors, and notifies the diagnostic tester 11 of any self-repair operations that have been performed.

The ECUs 101 of the diagnostic architecture 10 are part of different networks present in the vehicle, such as CAN (Controller Area Network), LIN (Local Interconnect Network), FlexRay and Ethernet. Each of these networks has different protocols and data transmission rates. For instance, LIN is used for low-speed networks like sensors and actuators with a data rate of around 20 kbps, CAN may be used for communication between different ECUs with a data rate of around 1 to 5 Mbps, FlexRay may be used for safety-critical applications with a data rate of around 10 Mbps, and Ethernet may be used for infotainment systems, advanced driver assistance systems (ADAS), and wireless interfaces, e.g. 4G, Wi-Fi, etc., with a data rate ranging from megabits per second to gigabits per second.

The GWM 12 provides a single point of entry—from a logical viewpoint—for communication between the diagnostic tester 11 and the component-level diagnostic architecture 10 having the ECUs 101. The GWM 12 acts as a router for diagnostic messages from one network to another, e.g. from Ethernet frames to CAN bus frames and vice versa. In particular, the GWM 12 bridges between the external or off-board network of the diagnostic tester 11 and internal or on-board networks of the vehicle ECUs 101.

The diagnostic protocol used between the diagnostic tester 11 and the ECUs 101 is the Unified Diagnostics Services (UDS) protocol as defined in the ISO standard 14229-1. In particular, the UDS protocol for diagnostic communication for various different underlying network technologies has been addressed and specified in various ISO standards: ISO 14229-3 specifies UDS on CAN; ISO 14229-4 specifies UDS on FlexRay; and, ISO 14229-5 specifies UDS on Internet protocol. UDS protocol continues to be used for the purpose of diagnostic communication irrespective of the underlying network technology used in vehicle electrical architecture. This can restrict the diagnostic capabilities that may be delivered, while also restricting the scalability and/or flexibility of the overall diagnostics electrical architecture.

The standardised diagnostic transport protocol DoIP (Diagnostic Communication over Internet Protocol) is used in combination with the UDS protocol to package diagnostic messages in Ethernet frames for communication of the diagnostic tester 11 with the vehicle ECUs 101. The GWM 12 therefore routes the DoIP Ethernet frames from the diagnostic tester 11 to the relevant transport protocol for the particular ECU 101 to which the diagnostic message is to be sent, e.g. CAN, LIN, FlexRay frames etc. That is, the diagnostic tester 11 establishes p2p diagnostic communication via the DoIP gateway module 12 with the individual ECUs 101 in the vehicle architecture, i.e. the component-level diagnostic architecture 10, and UDS is used as the protocol for diagnostic communication throughout the diagnostics electrical architecture 10.

A single fault or failure in the vehicle may result in faults across a number of the ECUs 101. Each of the ECUs 101 will detect and report the faults pertinent to, or associated with, that particular ECU 101, and report these back to the diagnostic tester 11. This means that the diagnostic tester 11 may receive multiple fault codes—also referred to as diagnostic trouble codes (DTCs)—from multiple different ECUs 101. The diagnostic tester 11—or an engineer or service technician—must then analyse and interpret the received DTCs to determine the root cause of the multiple DTCs and therefore the correct diagnostic repair that needs to be performed.

Although many different diagnostic testers may access the ECUs 101, only a single diagnostic tester can establish diagnostic communication with the component-level diagnostic architecture 10 at any one time. Relative levels of priority between different diagnostic testers may therefore be set up in the GWM 12. For instance, a third party off-board tester such as an OBD scan tool or insurance dongle may be assigned a highest priority, a manufacturer off-board tester may be assigned as next highest priority, and an on-board SOTA may be assigned a lowest priority.

The present invention provides a vehicle diagnostics electrical architecture in which diagnostic capabilities of the vehicle—in particular ECUs of the vehicle—are offered as diagnostic services over a network service bus of the vehicle, e.g. to diagnostic testers off-board the vehicle and/or other modules on-board the vehicle. This is in contrast to the signal-oriented p2p diagnostic communication of the diagnostics electrical architecture 10 in FIG. 1. For instance, whereas individual ECUs in the electrical architecture FIG. 1 can respond to a diagnostic tester with signals having raw diagnostic object data relating to performed diagnostic tests (where the raw data must then be interpreted off-board the vehicle), in the present invention the ECUs can respond to a diagnostic tester with interpreted or evaluated data or values relating to performed diagnostic tests. This is described in detail below.

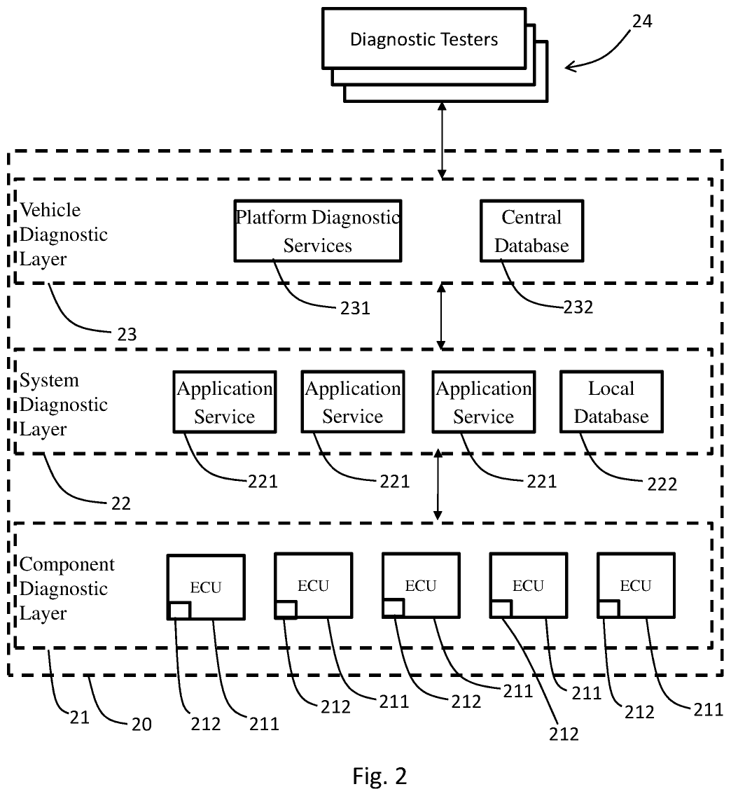

FIG. 2 illustrates another diagnostics electrical architecture 20 for a vehicle. Unlike in FIG. 1, in FIG. 2 the architecture 20 is a hierarchical diagnostic architecture 20 for a vehicle. This may also be referred to as a layered diagnostic architecture 20. Unlike the non-hierarchical architectures 10 of FIG. 1, the hierarchical architecture 20 includes a number of diagnostic layers 21, 22, 23. Similarly to the non-hierarchical architecture 10 of FIG. 1, the hierarchical architecture 20 has a component diagnostic layer 21 including a number of ECUs 211 each for performing different functions on the vehicle.

Each of the ECUs 211 of the hierarchical diagnostic architecture 20 has a local diagnostic server or module 212. Each diagnostic server 212 provides the capability to read fault record data associated with the associated ECU 211 and to initiate ECU self-tests to determine whether all of the inputs and outputs to the ECU are connected, configured and functioning as designed, and that the parts or software of the ECU, as well as the sensors connected to the ECU, are functioning correctly. In addition to these ‘pull’ mechanisms for retrieving fault data from the ECUs 211, the ECUs 211 are able to ‘push’ or transmit fault data to higher levels or layers 22, 23 of the hierarchical diagnostic architecture 20, for example when a fault is detected or upon predefined events or triggers occurring.

Unlike the non-hierarchical architecture 10 of FIG. 1, the hierarchical architecture 20 also includes two supervisory diagnostic layers 22, 23 over or between the component diagnostic layer 21 and diagnostic testers 24 on-board or off-board the vehicle arranged to make diagnostic communication with the hierarchical diagnostic architecture 20. The provision of such supervisory layers 22, 23 enables diagnostic monitoring and reporting to be made at a higher level than the component level diagnostics provided by the ECUs 211 in the component diagnostic layer 21. Whereas diagnostics performed in the component diagnostic layer 21 is restricted to determining and reporting faults associated with particular ECUs in isolation from other ECUs, supervisory layers have an overview of a number of different ECUs 211 in the lower layer 21 and, as such, diagnostics performed in the supervisory layers can aggregate fault data from a number of different ECUs 211—or, more generally, fault data from lower layers—to provide a clearer diagnostic overview of vehicle systems.

In the described example, the hierarchical diagnostic architecture 20 includes a system diagnostic layer 22 over the component diagnostic layer 21, and a vehicle diagnostic layer 23 over the system diagnostic layer 22 and arranged to make diagnostic communication with the diagnostic testers 24. In the system diagnostic layer 22, fault data from a plurality of the ECUs 211 is analysed and interpreted for each of a number of application services. Each application service requires certain functions provided by certain individual components or ECUs 211. As an example, vehicle speed may be offered or provided as an application service of the vehicle. In order to determine vehicle speed, wheel speed sensor signals need to be provided by each of the four wheel speed sensors of the vehicle.

Diagnostics may then be performed at a ‘service level’ for each of the different application services that are provided based on the fault data from the relevant ECUs. In particular, the system diagnostic layer 22 includes a number of application service interface modules 221 each connected to a number of the ECUs 211 in the component diagnostic layer 21. Note that a given ECU 211 may provide fault data to a number of different application service modules 221 courtesy of the hierarchical architecture. Diagnostic notifications may then be sent from the application service modules 221 to a higher layer of the architecture 20, in this case the vehicle diagnostic layer 23. The system diagnostic layer 22 also includes a local database or register 222 which may be used to store fault data or other notifications from the ECUs 211 in the component diagnostic layer 21.

In the vehicle diagnostics layer 23, fault data from a plurality of the application service modules 221 is analysed and interpreted for each of a number of customer-facing vehicle features. These user features may be regarded as vehicle features that are available to assist the user in driving the vehicle, or other vehicle features to provide entertainment, comfort, etc., to a vehicle user. Such vehicle features may include, for instance, a direction indicator feature or a lane change assist feature.

Diagnostics may then be performed at a ‘vehicle level’ or ‘vehicle feature level’ for each of the different vehicle user features that are provided based on the fault data from the relevant application service modules 221. In particular, the vehicle diagnostic layer 23 includes a platform diagnostic services module 231 connected to the application service modules 221 in the system diagnostic layer 22. Diagnostic notifications may then be sent from the platform diagnostic services module 231 to the diagnostic testers 24 either on-board or off-board the vehicle. The vehicle diagnostic layer 23 also includes a central database or register 232 which may be used to store fault data or other notifications from the application service modules 221 in the system diagnostic layer 22. The central database 232 also includes a current list of application services provided by the vehicle, which may be added to or amended over time.

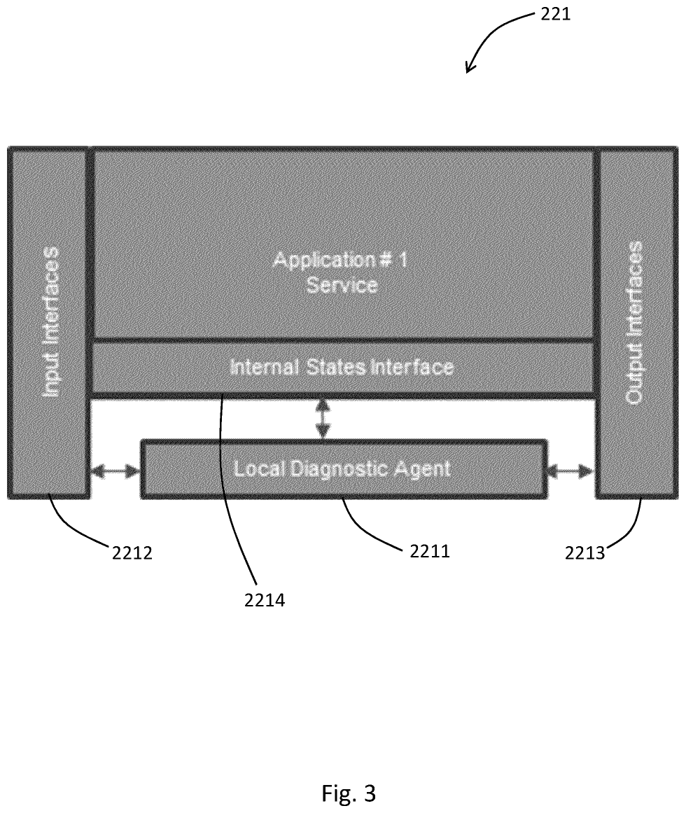

FIG. 3 illustrates one of the application service modules 221 from FIG. 2 in greater detail. In particular, each of the application service modules 221 includes a local diagnostic agent 2211, analogous in some ways to the diagnostic servers 212 of the ECUs. In particular, the local diagnostic agent 2211 is integral with the associated application service module 221 and has direct access to all of the inputs to, and outputs from, the module 221, as well as direct access to the internal states of the application service module 221. That is, the local diagnostic agent 2211 is connected to respective interfaces of the inputs 2212, outputs 2213 and internal states 2214 of the module 221. In the example of FIG. 2, the local diagnostic agent 2211 may then perform diagnostics at a ‘service level’ of the hierarchical network architecture 20 based on the accessed data (which can include fault data received from a number of the ECUs 211, for example).

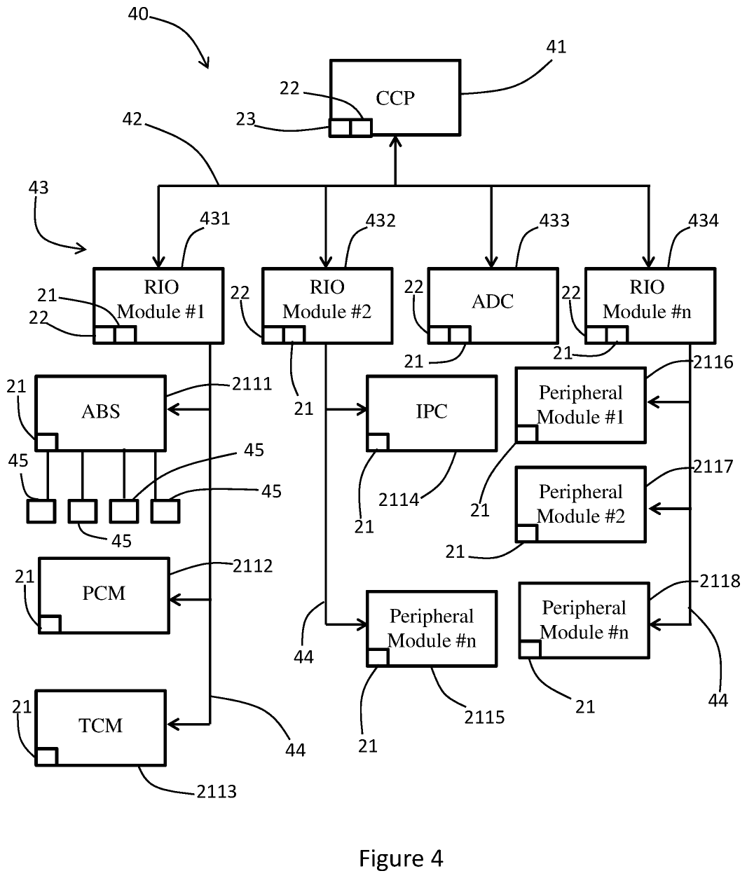

FIG. 4 illustrates a vehicle network architecture 40 including a number of connected computing devices disposed in the vehicle. The network architecture 40 includes a central compute platform (CCP) 41. The CCP 41 is connected via an Ethernet data backbone 42 to a number of other compute platforms in the form of domain controllers or zonal compute platforms (CPs), or remote input/output (RIO) modules 43. Each of these CPs and RIOs 43 are further connected to a number of the ECUs 211 via conventional networks 44 such as CAN, FlexRay or LIN.

The computing devices may be provided by suitable software running on any suitable computing substrate using conventional or customer processors and memory. Some of the computing devices may use a common computing substrate (for example, they may run on the same server) or separate substrates, or one or some of the computing devices may themselves be distributed between multiple computing devices.

In the illustrative described example, the CCP 41 is connected to four CPs and RIOs 43 along the Ethernet backbone network, in particular to three RIO modules 431, 432, 434 and a ADC (ADAS domain controller) 433. In the case of the architecture 20, a first of the RIOs 431 is connected to three ECUs 211 along the conventional network 44, in particular to an ABS module 2111, a PCM 2112 and a TCM 2113. The ABS module 2111 is further connected to four wheel speed sensors 45 for respective ones of the four wheels of the vehicle. A second of the RIOs 432 is connected to an IPC 2114 and a number of other peripheral modules or ECUs 2115 along the conventional network 44. An nth one of the RIOs 434 is also connected to a number of peripheral modules 2116, 2117, 2118 along the conventional network 44.

The different diagnostic layers 21, 22, 23 of the hierarchical diagnostic architecture 20 of FIG. 2 are hosted on different computer devices or modules of the vehicle network architecture 40. In particular, the vehicle diagnostic layer 23 is hosted on the CCP 41, the system diagnostic layer 22 is hosted on the CP/RIOs 43 and/or the CCP 41, and the component diagnostic layer 21 is hosted on the ECUs 211 and/or the CP/RIOs 43, as indicated in FIG. 4.

Unlike the ‘signal-oriented’ diagnostics of the architecture 10 of FIG. 1, the ‘service-oriented’ diagnostics of the architecture 20 of FIG. 2 does not use UDS as the protocol for diagnostic communication throughout the diagnostic architecture 20. Either the diagnostic testers 24 that establish diagnostic communication with the vehicle support a service-oriented diagnostics interface directly, or the platform diagnostic services module 231 performs conversion from UDS (between the testers 24 and the platform diagnostic services module 231) to service-oriented diagnostic communication (between the platform diagnostic services module 231 and the rest of the vehicle architecture 20), and vice-versa.

Application services—via the application service modules 221—are offered by various ones of the RIOs 43 connected over the Ethernet data backbone 42. These application services are available to be subscribed to, unsubscribed from, by the testers 24 or other components/modules of the vehicle over the network service bus 42. It is noted that modules that are not connected directly to the Ethernet backbone network 42 cannot offer diagnostic services. In the example of FIG. 2 the application service modules 221 are part of the service layer 22, which is hosted on the CCP 41 and/or RIOs 42. As the CCP 41 and/or RIOs 42 are connected directly to the Ethernet backbone 42—as seen in FIG. 4—then the application service modules 221 are always connected directly to the Ethernet backbone 42 in this case. In a case in which (peripheral) modules/ECUs are not connected directly to the Ethernet backbone and, as such, not able to offer diagnostic services, then they may publish equivalent network signal interfaces for the diagnostic services over one of the conventional sub-networks, e.g. CAN, LIN, FlexRay. A diagnostic signal manager module hosted on the RIOs 43 then manages a mapping between diagnostic signals from the ECUs and diagnostic services offered to, for example, a tester. That is, the diagnostic signal manager acts as local gateways between the Ethernet data backbone and individual sub-networks of CAN/LIN/FlexRay networks.

With reference to FIG. 4, an example is described to highlight the benefits of a service-oriented diagnostic architecture with local diagnostic agents. In particular, in this example vehicle speed is offered as a service, with wheel speed signals from each of four wheel speed sensors, i.e. one for each wheel of the vehicle.

The ABS module 2111 receives wheel speeds from the four wheel speed sensors 45 connected to the ABS 2111 via the conventional network 44. The RIO#1 module 431—which is connected directly to the Ethernet backbone 42—computes the vehicle speed from the wheel speed signals received over the conventional network 44 from the ABS module 2111. The RIO#1 module 431 then offers vehicle speed as a service for modules participating on the service-oriented architecture, with quality of service being added to the service interface. The RIO#1 module 431 then routes the calculated vehicle speed signal back over the conventional networks 44 that are connected to the RIO#1 module 431.

Other modules that are connected directly to the Ethernet backbone network 42 may then subscribe to the vehicle speed service offered in the RIO#1 module 431. For example, the RIO#2 module 432 subscribes to the vehicle speed service and uses this as input for applications/services hosted on the module 432. In addition, the RIO#2 module 432 provides reverse translation from service-oriented communication to signal-oriented communication and transmits the obtained vehicle speed signal over the conventional networks 44 that are connected to the RIO#2 module 432. Also, the ADC module 433 subscribes to the vehicle speed service from the Ethernet service bus 42 and uses this for its own applications/services.

The PCM 2112 and TCM 2113 are connected over the conventional network 44 to the RIO#1 module 431, and so these modules 2112, 2113 receive the vehicle speed signal transmitted by the RIO#1 module 431 to deliver their own functionality. Similarly, the IPC module 2114 is connected over the conventional network 44 to the RIO#2 module 432, and so the IPC module 2114 receives the vehicle speed signal transmitted by the RIO#2 module 432 to deliver its own functionality.

In terms of diagnostics, faults or failures in relation to the wheels speed sensors or signals may be reported at a service level, which advantageously can provide an interpreted view of the failure rather than raw diagnostic trouble codes (DTCs) which then need to be analysed off-board the vehicle to find a root cause of the failure.

For instance, if a first one of the wheel speed sensors 45 develops a fault then this will be detected by the diagnostic server in the ABS module 2111, which will generate a DTC, e.g. that there is short or open circuit to the wheel speed sensor 45. Referring to FIG. 4, the failure of the wheel speed sensor 45 will also be detected by the RIO module #1 431, which will also generate a DTC, e.g. that invalid serial data from the wheel speed sensor 45 has been received. In a signal-oriented diagnostic architecture, both of these separate DTCs may be reported and then an analysis of the underlying or root fault would need to be undertaken. In contrast, in the service-oriented diagnostic architecture triaging of the DTCs may be performed in the system diagnostic layer 22—in particular, in a local diagnostic agent 2211 of an application service module—to establish the root fault causing the multiple DTCs. In this case, the triaging establishes that the wheel speed sensor 45 is faulty and therefore only reports the DTC code generated by the ABS module 2111.

As another example, and with continued reference to FIG. 4, consider a scenario in which three of the wheel sensors 45 develop a fault. In this case, the ABS module 2111 will generate three DTCs, i.e. that there is short or open circuit to each of the three wheel speed sensors 45. The RIO module #1 431 will also generate three DTCs, i.e. that invalid serial data from each of the three faulty wheel speed sensor 45 has been received. Unlike in the previous example, however, if three wheel speed sensors are faulty then a calculation of vehicle speed cannot be made such that vehicle speed cannot be offered as a service by the RIO module #1 431. There are many modules of the vehicle that make use of the calculated vehicle speed signal, as outlined above. The RIO module #2 432 generates a DTC as the vehicle speed service is not received as a service along the Ethernet network 42, e.g. invalid vehicle speed signal, and the IPC module 2114 also generates a DTC, e.g. signal plausibility failure in that the steering column cannot be unlocked, or the engine cannot be started, because of an incorrect vehicle speed. Also, the ADC module 433 also makes use of the vehicle speed service, e.g. as part of a cruise control function, and so it generates a DTC as the vehicle speed is not received as a service along the Ethernet network 42, e.g. invalid vehicle speed signal. In addition, the PCM 2112 and TCM 2113 may use the vehicle speed signal transmitted along the conventional network 44 by the RIO module #1 431, and therefore these modules will generate DTCs when it is not received. In a signal-oriented diagnostic structure, each of these nine separate DTCs (two for the TCM 2113) may be reported and then an analysis of the underlying or root fault would need to be undertaken. In contrast, in a service-oriented diagnostic architecture service-level analysis of the DTCs may be performed in the system diagnostic layer 22—in this case hosted by the domain controllers 431, 432, 433—and in the vehicle diagnostic layer 23—in this case hosted in the CCP 41 —to establish the root fault causing the multiple DTCs. In this case, the service-level diagnostics establishes that three of the wheel speed sensors 45 are faulty and therefore only reports the three DTC codes associated with the wheel speed sensor faults generated by the ABS module 2111.

As a further example, consider that the conventional network communication bus 44 connected to the RIO module #1 431 is off/faulty. In this case, the RIO module #1 431 would generate a DTC to this effect. The ABS, PCM and TCM 2111, 2112, 2113 are all on this communication bus 44, and so each of these modules also generates a DTC to this effect. The RIO module #2 432 and ADC 433 need to communicate with the ABS module 2111 and so each generate a DTC that communication with the ABS module 2111 has been lost. Similarly, the IPC module 2114 needs to communicate with the ABS module 2111 and so generates a DTC that communication with the ABS module 2111 has been lost. In a signal-oriented diagnostic structure, the ‘communication bus off’ DTC and the ‘lost communication with ABS’ DTC would be reported and then an analysis of the underlying or root fault would need to be undertaken. In contrast, in the service-oriented diagnostic architecture service-level analysis of the DTCs may be performed in the system and vehicle diagnostic layers 22, 23 to determine that communication bus being off or faulty is the root cause, and therefore only the ‘communication bus off’ DTC is reported.

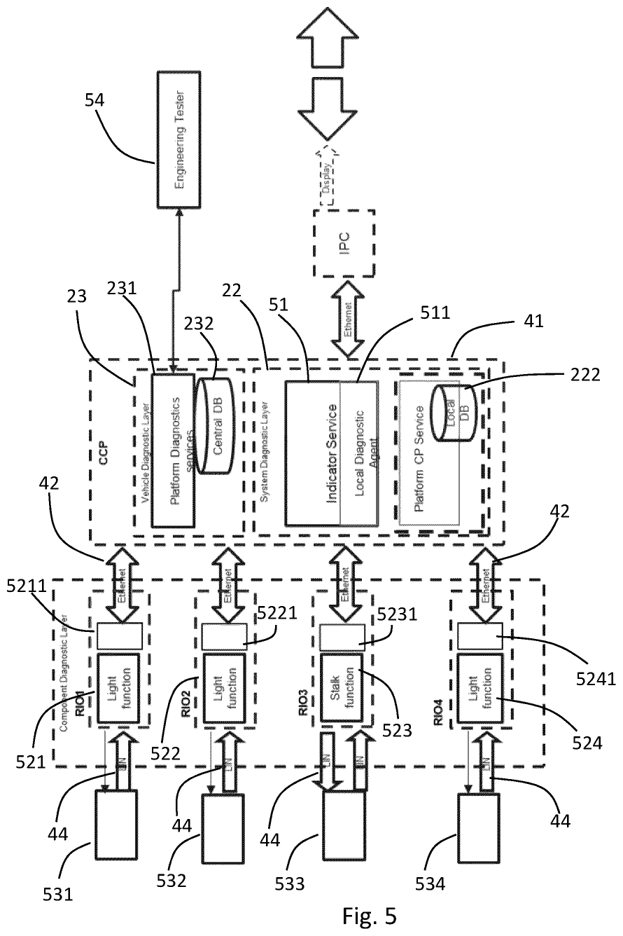

FIG. 5 illustrates an example of how the hierarchical diagnostics electrical architecture 20 of FIG. 2 may provide application services for a vehicle user feature in the form of a direction indicator feature. The direction indication feature has been decomposed into one application service 51 in the system diagnostic layer (or second diagnostic layer) 22, and four functions 521, 522, 523, 524 in the component diagnostic layer (or first diagnostic layer) 21. In the described example, both the vehicle diagnostic layer 23 and the system diagnostic layer 22 are hosted on the CCP 41, and the component diagnostic layer 21 is hosted on the RIOs 43. The four function components or modules 521, 522, 523, 524 are each hosted on a different one of the RIOs 43. The four function components 521, 522, 523, 524 each have an associated diagnostic server 5211, 5221, 5231, 5241.

In the described example, the four functions 521, 522, 523, 524 include three light functions 521, 522, 524 and a stalk function 523. Each of the functions 521, 522, 523, 524 receives sensor data from respective sensors 531, 532, 533, 534 connected thereto via the conventional networks 44, specifically the LIN in the case. In particular, the sensors include sensors associated with different indicator lights on the vehicle, e.g. at the front or rear of the vehicle, or on a wing mirror. Data from each of the function modules 521, 522, 523, 524 is transmitted to the indicator service module 51 via the Ethernet backbone network 42.

Regarding diagnostic capabilities, each of the diagnostic servers 5211, 5221, 5231, 5241 may perform diagnostic operations on the received sensor output data together with the input/output connections of the function modules 521, 522, 523, 524. Diagnostic notifications, for example in the form of fault codes, are transmitted to the indicator application service 51 and, in particular, the local diagnostic agent 511 of the service 51 perform service-level diagnostics on the received diagnostic notifications from the function modules 521, 522, 523, 524 and also the internal states of the indicator module 51.

As shown in FIG. 5, an off-board engineering diagnostic tester 54 is connected to the platform diagnostics services module 231 in the vehicle diagnostic layer 23. As there is only one application service in the present example—namely, the indicator service 51—then there is no vehicle- or feature-level triage of diagnostic notifications in the vehicle diagnostic layer 23. The availability of the indicator service 51 is stored in the central database 232. The engineering tester 54 may be made aware of the indicator service 51, or the availability of the indicator service 51 may be sent to the engineering tester 54, so that diagnostic messages relating to the indicator service 51 may be sent to the engineering tester 54. In particular, the local diagnostic agent 511 may generate a group diagnostic notification based on its diagnostic operations.

In the described example, the diagnostic communication between the engineering tester 54 off-board the vehicle and the platform services module 231 on-board the vehicle is sent using the UDS transport protocol. A separate gateway module in the vehicle architecture is not essential. This is because such gateway functionality may be provided as part of the platform diagnostics services module 231. Namely, to convert the diagnostic communication between service-oriented diagnostic communication and UDS on Do IP so that successful diagnostic communication between the tester 54 and the vehicle architecture 20 is possible.

The engineering tester 54 can dynamically discover the indicator service 51 by subscribing to an up-to-date list of diagnostic capabilities of the offered services stored in the on-board diagnostic registry or central database 232. In particular, the central database 232 stores a list of faults, sensor readings, etc. that are supported by the diagnostic service. If one of the functions 521, 522, 523, 524 of the indicator service 51 is added/removed/amended then the diagnostic capabilities of the indicator service 51 are updated in the central registry 232. For instance, the engineering tester 54 may send a request to read fault information associated with the indicator service 51. The ECUs 5211, 5221, 5231, 5241 respond with raw data in the form of relevant diagnostic objects, e.g. fault codes/DTCs. The diagnostic registry of the on-board central database 232 may then be used to interpret the DTCs, and send the interpreted diagnostic objects back to the diagnostic tester 54 such that the diagnostic data sent off-board the vehicle does not need to be interpreted by the tester.

Component-based diagnostics allows for the detection of physical faults of sensors and actuators. However, it does not allow determination as to whether received sensor data is fit for purpose for the application that is using it. That is, the received data may be outside of a range that is useful for a particular application even if the sensor is not faulty as such. The quality of service may therefore be improved by introducing functional operating range monitoring for received sensor data.

Physical faults with the sensors and actuators may be monitored at a component level, i.e. ECU level. This includes physical I/O faults, e.g. short circuit or open circuit faults. DTC logs are created upon detection of such faults. At a service level, the local diagnostic agents 2211 can perform functional operating range monitoring of the sensor data. Specifically, a local diagnostic agent 2211 can assess the functional validity of the received sensor data in given operating states of a particular system, and fuse received data from other sources in the given context. The local diagnostic agent 2211 will create a DTC log and generate an event notification if it is determined that the received data is not fit for purpose even though no physical faults have been detected at the component level.

Once the local diagnostic agent 2211 generates such a notification it is assessed at a vehicle level through vehicle-level supervisory services against vehicle states and power mode. As an outcome of this assessment a predictive event notification may be generated, if necessary, i.e. an event notification predicting possible sensor or actuator failure. As such, the diagnostic architecture 20 is not limited to reactive event notifications.

Although the example of FIG. 2 illustrates a service-oriented diagnostics electrical architecture that is hierarchical in nature having a number of diagnostic layers, in different examples a service-oriented diagnostics electrical architecture that is non-hierarchical in nature is also possible. In such examples, individual ECUs may broadcast or publish offered services. For instance, other components such as external diagnostic testers may subscribe to particular ECUs to receive event notifications.

Differences between the non-hierarchical, signal-oriented (i.e. UDS protocol) architecture 10 of FIG. 1, and the non-hierarchical and hierarchical variations of a service-oriented architecture (such as the hierarchical, service-oriented architecture 20 of FIG. 2), is now described. In particular, the steps involved in the design, deployment, runtime and update phases of diagnostic use cases for each architecture is now described.

Firstly, the diagnostic design phase is described. For UDS communication, UDS protocol adaptation is needed. This involves identifying all the diagnostic use cases for a particular system. Manufacturer-specific rules and restrictions are then defined on top of the UDS protocol specification for diagnostic communication, i.e. ISO 14229-1, as mentioned above. Note that not all manufacturer-specific customisation or extensions may be feasible within the UDS framework.

For service-oriented diagnostics (SoD), SoD design is needed. For both flat and layered architectures this involves identifying all the diagnostic use cases for a particular system, as for UDS communication. Unlike UDS, however, SoD services fulfilling all of the diagnostic use cases are designed, specifying a service provider and consumer relationships. A suitable communication middleware that fulfils all of the identified diagnostic use cases is then chosen. In particular, an suitable industry standard middleware may be chosen, for example, SOME/IP (Scalable service-oriented middleware over IP), REST (Representational state transfer), DDS (Data distribution service), etc. SoD service interfaces then need to be designed. In particular, properties, methods, events and fields are specified on top of the chosen middleware. For the layered SoD architecture, SoD service interfaces are then instantiated across various diagnostic layers of the architecture, e.g. the system and vehicle layers described above.

For both UDS and SoD communication, diagnostic objects are designed. In both cases, the failure modes and fault causes for the system are identified. This may be achieved using failure mode effects analysis (FMEA) or similar. In particular, the diagnostic objects—in the form of diagnostic trouble codes (DTCs)—for monitoring the identified failure modes and fault causes are designed. Snapshot information to capture environmental conditions when a fault occurs is also designed. A diagnostic extract file (DEXT) for configuring the ECU software is created. A diagnostic description file (ODX) for configuring a diagnostic tester is also created.

Secondly, the diagnostic deployment phase is described. For UDS communication, the ECU software platform is configured using the DEXT file, and the diagnostic tester is configured using the ODX file. An external process ensures that revisions of the DEXT and ODX files are compatible between the on-board ECUs and the diagnostic tester.

For SoD communication, the SoD service interface is deployed on the chosen communication middleware, e.g. SOME/IP. The ECU software platform is configured using both the DEXT and ODX files. Note that this is in contrast to UDS communication, in which the ODX file is used to configure the diagnostic tester. For flat (non-hierarchical) SoD, the ECU ODX file is embedded in the ECU software, and for layered (hierarchical) SoD, the vehicle ODX file is embedded in the vehicle diagnostic layer of the architecture. This means that external, off-board diagnostic testers do not need to be configured using the ODX file for (both flat and layered) SoD communication, which significantly simplifies the complexity of external processes that need to be managed, by a manufacturer for example. In addition, for the layered SoD central management of the ODX file in the vehicle diagnostic layer further simplifies processes and communication.

Thirdly, the diagnostic runtime phase is considered. For UDS communication, the off-board diagnostic tester establishes diagnostic communication with the target ECU or module in the vehicle by using the UDS protocol. This diagnostic communication is successful if the ODX file used for configuration of the tester is the compatible with the DEXT file used for configuration of the ECU software stack in the vehicle. In an example, the off-board diagnostic tester sends a request message, for instance a request for read DTC information. The on-board target ECU responds with a UDS response message including the requested diagnostic objects having the appropriate statically configured DTCs using ‘raw’ values. The diagnostic tester then interprets the received raw values of the diagnostic objects by using the ODX file configured with the diagnostic tester. The diagnostic can correctly interpret the response from the ECU provided that the ODX file used for the tester is the same/compatible with the DEXT file used for configuring the ECU software.

For SoD communication, the off-board diagnostic tester establishes diagnostic communication with the target ECU or module in the vehicle by using the SoD interface. This diagnostic communication is successful if the diagnostic tester directly supports the SoD interface. Alternatively, the diagnostic tester uses UDS to communicate with the vehicle architecture, and a platform diagnostic services module in the vehicle architecture performs conversion between SoD and UDS on DoIP so that the diagnostic tester can communicate successfully with the target ECU through the SoD interface. The diagnostic tester is then able to dynamically discover or learn the diagnostic services that are offered or provided over the network service bus via the SoD service interfaces. In particular, a central database maintains a diagnostic service registry including a list of offered services, and the diagnostic tester subscribes to the diagnostics service registry to dynamically learn the available services. Note that the target ECU also subscribes to the diagnostics service registry. As the ODX file is embedded within the on-board architecture—in particular, in the ECU software for the flat architecture and in the vehicle diagnostic layer for the layered architecture—then the target ECU is able to respond to the diagnostic tester with interpreted values of the diagnostic objects (DTCs, events, snapshot date, etc.) instead of raw values of the diagnostic objects that need to be interpreted off-board the vehicle.

Finally, the diagnostic update phase is considered. The update may be in the form of, for example, a new application or diagnostic capability. For both UDS and SoD communication, the DEXT and ODX files are updated to reflect the changes in diagnostic capability. A new version of the DEXT file is released for the ECU software configuration and a new version of the ODX file is released for tester configuration. For both UDS and SoD configuration, the ECU software is reconfigured using the new DEXT file. However, unlike for UDS communication, for SoD communication the new ODX is also used to reconfigure the ECU software. For UDS communication the diagnostic tester needs to be reconfigured using the new ODX file by using an external process. In contrast, for SoD communication no such reconfiguration of the external diagnostic tester is needed. For UDS communication, the target ECU will support the new diagnostic capability when requested by the diagnostic tester, provided both the tester and target ECU have been statically updated to recognise the change. In contrast, for SoD communication the diagnostic tester dynamically discovers the new diagnostic capabilities by discovering the new diagnostic services that are being offered in the updated diagnostic service registry and subscribing to them. As described above, diagnostic communication between the diagnostic tester and the target ECU can be established successfully provided that the diagnostic tester support the SoD interface or by performing conversion between UDS and SoD in the platform diagnostic services module of the vehicle architecture.

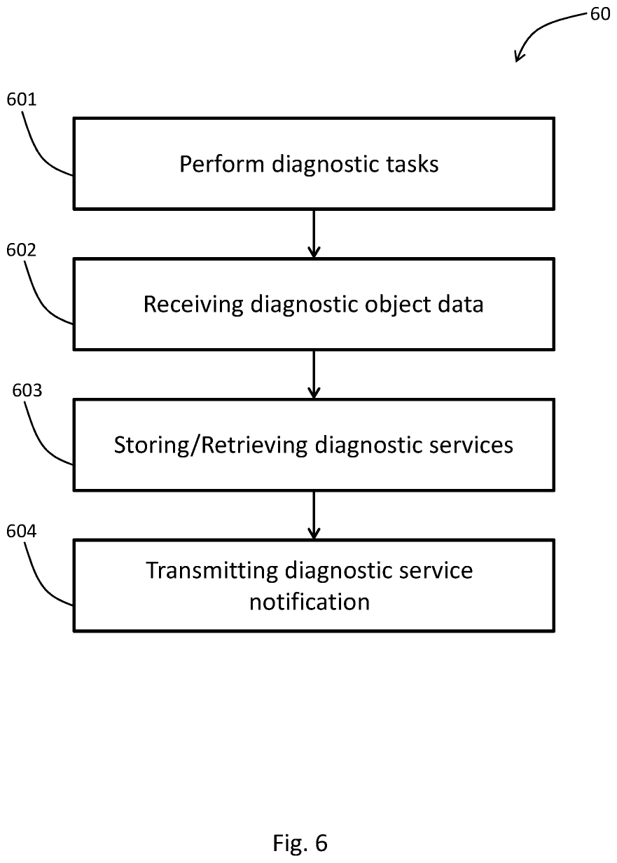

FIG. 6 outlines the steps of a method 60 of providing diagnostic communication in a diagnostics electrical architecture of a vehicle. The vehicle has a network including a plurality of on-board computing devices for hosting a diagnostics electrical architecture. The on-board computing devices include the CCP 41, a plurality of RIO modules 43, or other zonal computing devices or domain controllers, and a plurality of ECUs or other peripheral modules 211. For instance, the diagnostics electrical architecture may be the hierarchical architecture 20 of FIG. 2. Alternatively, the diagnostics electrical architecture may be a non-hierarchical architecture. The architecture 20 includes electronic control units 211 each having a diagnostics server module 212. The architecture 20 also includes service interface modules 221, 231 arranged to allow diagnostic communication between the electronic control units 211 and a network service bus 42 of the vehicle. In the described example, the architecture 20 comprises a number of application service interface modules 221 in the system layer, and a platform service interface module 231 in the vehicle layer. The architecture 20 also includes a diagnostic service registry module 222, 232 storing a list of diagnostic services offered via the service interface modules 221, 231.

At step 601, the diagnostics server modules 212 perform diagnostic tasks to generate diagnostic object data. In particular, each diagnostic server 212 has a number of associated diagnostic objects—which may include DTCs, events, data IDs (DIDs) and/or diagnostic control routines—for diagnostic monitoring of the various possible failure modes associated with the respective ECU 211, input/output/internal state control, and/or module identification. Specific diagnostic object data may be generated in response to a request or other event. The diagnostic object data comprises raw data or codes that need to be interpreted to identify the associated fault. For example, a DEXT file may specify the configuration parameters for configuring the ECU diagnostic software and the diagnostic objects supported by the ECU software.

At step 602, the service interface modules receive the generated diagnostic object data from the ECUs 211. In particular, in the described example platform diagnostic services module 231 may receive diagnostic object data from each of a plurality of the ECUs 211.

At step 603, diagnostic services data is retrieved from the diagnostic service registry module 232. In particular, the retrieved diagnostic services data comprises diagnostic capability descriptions of the generated diagnostic object data. For example, the diagnostics services data may include a diagnostic description file, e.g. an ODX file.

At step 604, a diagnostic service notification is transmitted over the network service bus, e.g. the Ethernet backbone 42. In particular, the diagnostic service notification is based on the generated diagnostic object data and the diagnostic services data. That is, the transmitted diagnostic service notification comprises interpreted values or data of the raw (non-interpreted) diagnostic object data. For instance, the diagnostic service notification may be transmitted off-board the vehicle to a diagnostic tester 24, which therefore advantageously does not then need to interpret the received message from the vehicle architecture 20.

The diagnostic service notification may be an autonomous diagnostic service notification, i.e. automatically generated when an event/fault occurs. The diagnostic service notification may also be a response to a diagnostic request received from an on-board or off-board diagnostic tester.

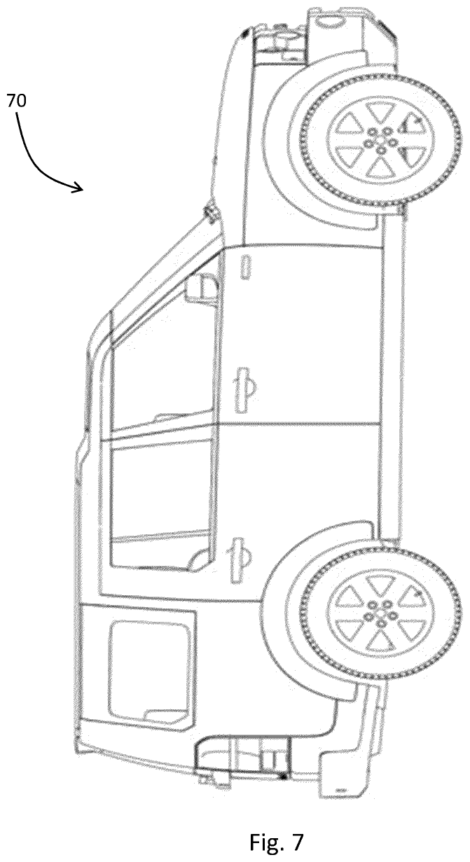

FIG. 7 shows a vehicle 70, which in the illustrated embodiment comprises an automobile, having the network architecture 40 (not shown in FIG. 8) and hosting the diagnostics electrical architecture 20. I

Embodiments of the invention are advantageous in that they provide for service-oriented diagnostic communication in a vehicle electrical network architecture. This is in contrast to known systems in which signal-oriented diagnostic communication is used, e.g. using the UDS protocol. The service-oriented diagnostic communication of the present invention allows for diagnostic tasks to be offered as services across the vehicle service bus, e.g. to diagnostic testers off-board the vehicle or to other modules that are part of the vehicle network architecture. In particular, the service-oriented diagnostic communication allows for interpreted diagnostic messages to be transmitted to, e.g. an external diagnostic tester, instead of raw diagnostic data, e.g. one or more DTCs, that then need to be interpreted off-board the vehicle.

Embodiments of the invention are particularly advantageous in that they use service-oriented architecture middleware independence for diagnostics communication. This allows for provision of a scalable and flexible on-board service diagnostics interface. In particular, updates to ECU diagnostic capabilities do not require re-flashing of the ECU. Also, this allows for diagnostics services to be dynamically discovered by other components, for example, external diagnostics testers, such that these components do not need to be specifically configured for compatibility with any ECU diagnostic updates.

Known systems do not provide such capabilities, at least not to the fullest extent. Some known systems offer middleware supports for a service-oriented architecture; however, these systems only offer support for UDS diagnostics within the basic software components of the ECUs. As such, known systems inherit the limitations of the UDS protocol. For instance, in some known systems the diagnostic capabilities of the ECU need to be statically configured during the design and development phases of the ECU. That is, each time there is a change in the diagnostic capabilities of an ECU the basic software layers of the ECU need to be statically reconfigured and re-flashed. Some known systems may offer a degree of dynamic configuration of the basic software layers of the ECU, e.g. functions may be provided for updating certain software packages without re-flashing the entire ECU. In such a case, individual software packages are clustered and have their own diagnostic addresses which are used to access a diagnostic function or software update via a diagnostic manager component, where this component is configurable for each software package using a further file. However, none of these known systems provide capability/flexibility outside of UDS-offered services.

Embodiments of the invention are advantageous in that components, e.g. an external diagnostic tester, can subscribe to particular services so that diagnostic updates to a service may be learned dynamically. In particular, the present invention advantageously allows for services to generate or publish event notifications to all subscribers of the service based on event triggers, e.g. an update in diagnostic capabilities of the service. In addition, the event notifications may advantageously be provided with delivery guarantee to the service subscribers.

Embodiments of the invention are advantageous in that they provide logical and physical separation between external connectivity modules, i.e. diagnostic testers, and vehicle core modules, i.e. ECUs, from a diagnostic access point of view by introducing a layer of abstraction via service interface modules. This increases security and makes the diagnostic architecture less vulnerable to cyber-attacks. This is in contrast to p2p diagnostic architectures in which external diagnostic testers can establish direct communication paths to on-board ECUs.

Embodiments of the invention are advantageous in that they provide dynamic diagnostic resource conflict management. Specifically, embodiments of the invention advantageously permit simultaneous access of multiple different diagnostic testers, e.g. legislative scan tool, SOTA event, OBD scan tool, insurance dongle, etc. This is in contrast to some known systems which are limited to permitting access to one diagnostic tester at a time through a gateway module, even if the different testers require access to different system domains.

With reference to FIG. 8, there is illustrated a simplified example of an on-board computing device 800 described above. The on-board computing device 800 can comprise a control unit or computational device having one or more electronic processors (e.g., a microprocessor, a microcontroller, an application specific integrated circuit (ASIC), etc.), and may comprise a single control unit or computational device, or alternatively different functions of the or each on-board computing device 800 may be embodied in, or hosted in, different control units or computational devices. As used herein, the term “controller,” “control unit,” or “computational device” will be understood to include a single controller, control unit, or computational device, and a plurality of controllers, control units, or computational devices collectively operating to provide the required control functionality. A set of instructions could be provided which, when executed, cause the on-board computing device 800 to implement the control techniques described herein (including some or all of the functionality required for the method described herein). The set of instructions could be embedded in said one or more electronic processors of the on-board computing device 800; or alternatively, the set of instructions could be provided as software to be executed in the on-board computing device 800. A first controller or control unit may be implemented in software run on one or more processors. One or more other controllers or control units may be implemented in software run on one or more processors, optionally the same one or more processors as the first controller or control unit. Other arrangements are also useful.

In the example illustrated in FIG. 8, the on-board computing device 800 comprises at least one electronic processor 820 having one or more electrical input(s) 822 for receiving one or more (input signal(s)), and one or more electrical output(s) 824 for outputting one or more (output signal(s)). The on-board computing device 800 further comprises at least one memory device 830 electrically coupled to the at least one electronic processor 820 and having instructions 840 stored therein. The at least one electronic processor 820 is configured to access the at least one memory device 830 and execute the instructions 840 thereon.

The, or each, electronic processor 820 may comprise any suitable electronic processor (e.g., a microprocessor, a microcontroller, an ASIC, etc.) that is configured to execute electronic instructions. The, or each, electronic memory device 830 may comprise any suitable memory device and may store a variety of data, information, threshold value(s), lookup tables or other data structures, and/or instructions therein or thereon. In an embodiment, the memory device 830 has information and instructions for software, firmware, programs, algorithms, scripts, applications, etc. stored therein or thereon that may govern all or part of the methodology described herein. The processor, or each, electronic processor 820 may access the memory device 830 and execute and/or use that or those instructions and information to carry out or perform some or all of the functionality and methodology describe herein.

The at least one memory device 830 may comprise a computer-readable storage medium (e.g. a non-transitory or non-transient storage medium) that may comprise any mechanism for storing information in a form readable by a machine or electronic processors/computational devices, including, without limitation: a magnetic storage medium (e.g. floppy diskette); optical storage medium (e.g. CD-ROM); magneto optical storage medium; read only memory (ROM); random access memory (RAM); erasable programmable memory (e.g. EPROM ad EEPROM); flash memory; or electrical or other types of medium for storing such information/instructions.

An example on-board computing device 800 has been described comprising at least one electronic processor 820 configured to execute electronic instructions stored within at least one memory device 830, which when executed causes the electronic processor(s) 820 to carry out the method as hereinbefore described. However, it will be appreciated that embodiments of the present invention can be realised in any suitable form of hardware, software or a combination of hardware and software. For example, it is contemplated that the present invention is not limited to being implemented by way of programmable processing devices, and that at least some of, and in some embodiments all of, the functionality and or method steps of the present invention may equally be implemented by way of non-programmable hardware, such as by way of non-programmable ASIC, Boolean logic circuitry, etc.

It will be appreciated that various changes and modifications can be made to the present invention without departing from the scope of the present application. For example, all of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments which fall within the scope of the claims.

1. A diagnostics electrical architecture for a vehicle, the vehicle comprising a plurality of on-board computing devices for hosting the diagnostics electrical architecture, and the diagnostics electrical architecture comprising:
one or more electronic control units each comprising a diagnostics server module arranged to perform diagnostic tasks to generate diagnostic object data;
a service interface module arranged to allow diagnostic communication between the one or more electronic control units and a network service bus of the vehicle, the service interface module being arranged to receive the generated diagnostic object data; and,
a diagnostic services registry module arranged to store diagnostic services data indicative of diagnostic services provided by the service interface module, the diagnostic services data comprising diagnostic capability descriptions of the generated diagnostic object data,
wherein the service interface module is arranged to transmit a diagnostic service notification over the network service bus, the diagnostic service notification being based on the generated diagnostic object data and the diagnostic services data retrieved from the diagnostic services registry.

2. A diagnostics electrical architecture according to claim 1, wherein the diagnostic service notification is generated in response to a change in diagnostic capabilities provided by the service interface module;
optionally the change in diagnostic capabilities is caused by an addition or removal of diagnostic tasks performed by the one or more electronic control units;
optionally the change in diagnostic capabilities is caused by addition or removal of an electronic control unit associated with the service interface module.

3. A diagnostics electrical architecture according to claim 1, wherein the diagnostic service notification is generated in response to a request for diagnostic capabilities received by the service interface module;
optionally the request for diagnostic capabilities is received from a diagnostic tester off-board the vehicle.

4. A diagnostics electrical architecture according to claim 1, wherein the generated service notification is transmitted off-board the vehicle.

5. A diagnostics electrical architecture according to claim 1, wherein the generated diagnostic capability notification is used to update the diagnostic register module.

6. A diagnostics electrical architecture according to claim 1, wherein the service interface module is deployed on communication middleware on one or more of the on-board computing devices; optionally the communication middleware is one of:
SOME/IP (Scalable service-oriented middleware over IP);
REST (Representational state transfer); and,
DDS (Data distribution service).

7. A diagnostics electrical architecture according to claim 1, wherein the vehicle service bus comprises an Ethernet backbone network; optionally the service interface module is directly connected to the Ethernet backbone network.

8. A diagnostics electrical architecture according to claim 1, wherein the diagnostic services registry module is arranged to allow modules on-board and off-board the vehicle to subscribe thereto such that the modules dynamically learn the diagnostic services provided by the service interface module.

9. A diagnostics electrical architecture according to claim 1, the diagnostics electrical architecture being arranged to provide conversion between Unified Diagnostics Services (UDS) protocol communication and service-oriented diagnostics communication.

10. A diagnostics electrical architecture according to claim 1, wherein the diagnostics electrical architecture is a hierarchical architecture having a component diagnostic layer and at least one supervisory diagnostic layer, the component diagnostic layer comprising the one or more electronic units;
optionally the at least one supervisory diagnostic layer comprises the service interface module;
optionally the at least one supervisory diagnostic layer comprises the diagnostic services registry module;
optionally the at least one supervisory diagnostic layer comprises a system diagnostic layer and a vehicle diagnostic layer at a higher level of the architecture than the system diagnostic layer, the vehicle diagnostic layer comprising the service interface module, and the system diagnostic layer comprising an application service module comprising a local diagnostic agent arranged to aggregate the generated diagnostic service notifications received from the electronic control units to generate a supervisory-level diagnostic service notification;
optionally the supervisory-level diagnostic service notification is used to update the diagnostic services registry module.

11. A vehicle comprising a network architecture having a plurality of computing devices and hosting the diagnostics electrical architecture of claim 1.

12. A method of providing diagnostics communication in a diagnostics electrical architecture of a vehicle, the vehicle comprising a plurality of on-board computing devices for hosting the diagnostics electrical architecture, the diagnostics electrical architecture comprising:
one or more electronic control units each comprising a diagnostics server module;
a service interface module arranged to allow diagnostic communication between the one or more electronic control units and a network service bus of the vehicle; and,
a diagnostic services registry module,
the method comprising:
performing, by the diagnostics server module, diagnostic tasks to generate diagnostic object data;
receiving into the service interface module the generated diagnostic object data;
retrieving diagnostic services data from the diagnostic service registry module, the diagnostic services data comprising diagnostic capability descriptions of the generated diagnostic object data; and,
transmitting a diagnostic service notification over the network service bus, the diagnostic service notification being based on the generated diagnostic object data and the diagnostic services data.

13. A non-transitory computer-readable storage medium storing instructions thereon that when executed by one or more processors causes the one or more processors to perform the method of claim 12.
